(19) United States
(12) Patent Application Publication
(10) Pub. No.: US 2019/0106660 A1
(43) Pub. Date: Apr. 11, 2019

(54) Monitoring and Control of Fermentation Under Pressure

(71) Applicant: PicoBrew, Inc., Seattle, WA (US)

(72) Inventor: Avi R. Geiger, Seattle, WA (US)

(73) Assignee: PicoBrew, LLC

(21) Appl. No.: 15/725,840

(22) Filed: Oct. 5, 2017

(51) Int. Cl. C12C 11/00

(52) U.S. Cl. CPC C12C 11/006

(57) ABSTRACT

A fermentation monitoring system may detect pressure inside a fermenting vessel. Near the end of a fermentation cycle, pressure may be relieved in the vessel and a measurement of the rate of pressure increase may indicate how close the fermentation cycle may be to completion. The fermentation vessel may cause fermentation to occur at a pressure slightly higher than atmospheric pressure, such as 5 to 10 psig. Pressure may be relieved by a pressure relief valve, which may cause pressure to return to atmospheric pressure. The rate at which pressure returns may be used to determine how close the fermentation cycle is to completion.

### BACKGROUND

Fermentation is an age old process for using yeast or bacteria to convert sugars to acids, gases, or alcohol. Fermentation is used for making beer as well as many other foods.

As a process for making beer or other foods, a sugar source may be created, then yeast may be added to the sugar source. The fermentation process will typically rise quickly, then taper off as the sugar sources are consumed.

Because the fermentation process slows down over time, it can be difficult to determine the end of the fermentation process. As the food source for the yeasts or bacteria are depleted, the detectable effects of the fermentation process become less and less. For amateur brewers and professionals alike, there may be motivation to proceed to a stage of beer consumption. If the fermentation process is stopped too early, the beer may still contain unfermented sugars. In addition to imparting undesired tastes, unfermented sugars may continue fermentation in dispensing equipment, which may cause overpressure situations and lead to exploding bottles, for example.

### SUMMARY

A fermentation monitoring system may detect pressure inside a fermenting vessel. Near the end of a fermentation cycle, pressure may be relieved in the vessel and a measurement of the rate of pressure increase may indicate how close the fermentation cycle may be to completion. The fermentation vessel may cause fermentation to occur at a pressure slightly higher than atmospheric pressure, such as 5 to 10 psig. Pressure may be relieved by a pressure relief valve, which may cause pressure to return to atmospheric pressure. The rate at which pressure returns may be used to determine how close the fermentation cycle is to completion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a fermentation system.

FIG. 2 is a diagram illustration of an embodiment showing a schematic or functional representation of a fermentation system with other devices, such as a brewing system, recipe server, and other network connected devices.

FIG. 3A is a diagram illustration of an embodiment showing example pressure curves during the beginning of fermentation cycles.

FIG. 3B is a diagram illustration of an embodiment showing example pressure curves during the end of fermentation cycles.

FIG. 4 is a flowchart illustration of an embodiment showing a method for monitoring fermentation cycles at the beginning stages.

FIG. 5 is a flowchart illustration of an embodiment showing a method for monitoring fermentation cycles at the ending stages.

### DETAILED DESCRIPTION

Fermentation Monitoring for Pressurized Fermentation Process

A fermentation process may be performed under pressure. Such a fermentation process may be more tolerant of temperature or other variations, yet may yield an acceptable outcome. For example, by fermenting beer at a pressure of 5 to 10 psig, negative effects of fermenting above an ideal temperature can be mitigated. In some cases, a beer with a lager yeast that may conventionally be fermented at 45-55 F, may be fermented under 5-10 psig pressure at 70-80 F with acceptable results.

The fermentation process produces carbon dioxide or other gasses. The process may be used to pressurize a vessel during fermentation. The vessel may be started at atmospheric pressure, but a pressure regulator may cause pressure to rise to a predefined pressure setting. The pressure regulator may vent gasses as the pressure rises above the predefined pressure setting.

A pressure sensor may be used to measure the pressure inside a fermentation vessel, and a controller may monitor the pressure sensor. As a fermentation cycle begins, the controller may sense that the pressure increases from atmospheric to the predefined pressure over time, indicating that the fermentation cycle has begun as expected. If the pressure does not rise, the causes may be that the fermentation vessel is not sealed properly or that the fermentation cycle has not begun for some reason. In such cases, the controller may alert a user and may suggest troubleshooting or remediation steps.

In some cases, a system may have temperature sensors. Such temperature sensors may measure ambient temperature, the temperature of the vessel, the temperature of the liquid inside the vessel, or other temperatures. The location and sensing ability of temperature sensors may change from one design to another.

A controller may receive recipe information about the material being fermented. The recipe information may be used to estimate the expected behavior of a specific fermentation cycle. The recipe information may be used to estimate the amount of sugars to be fermented, and by knowing the performance of the yeast to be used, the expected fermentation rate may be calculated.

The calculated or estimated fermentation rates may be used to determine that fermentation began as expected as well as to estimate completion of fermentation. At the beginning stages of the fermentation cycle, the controller may sense the pressure rise inside the vessel. The rate of pressure rise and the time to reach pressurization may be factors that may determine whether the fermentation is progressing as expected.

In some cases, there may be a lag time between when fermentation begins and when the pressure rise may be detected. The lag time may be a period where an inoculant batch of yeast may begin activity and may begin to reproduce. If a pressure rise is not detected in a predefined period of time, the reasons may include that the vessel is not properly sealed or that fermentation was not started properly. The controller may alert a user and may provide steps to diagnose the situation.

When fermentation has not been detected, the controller may prompt a user to check that the vessel has been properly sealed and locked. Whether or not the user finds any issues, the user may be prompted to open the vessel and inspect the wort inside. If the wort has no foam, the user may be prompted to add a second batch of yeast and to reseal the vessel to restart fermentation. If the wort appears to have some foam, the fermentation may have begun and the user may be prompted to reseal the vessel and continue fermentation.

When fermentation begins, the controller may detect that pressure has risen in the vessel. As fermentation continues, the pressure may build to the point that the pressure regulator may vent any excess pressure to atmosphere.

Near the expected end of the fermentation cycle, the pressure may be vented, returning the vessel to atmospheric pressure. After venting, the vessel may be sealed and the pressure sensor may be monitored to determine how fast the pressure rises. If the pressure rises slowly or does not regain the full pressure of fermentation, the controller may determine that the fermentation has ended or is nearing completion. If the pressure rises quickly, the controller may determine that fermentation has additional time before completion.

One use scenario may be for the controller to alert a user to vent the vessel. A user may manually press a pressure relief valve to vent the vessel, which may cause the pressure to return to atmospheric or near-atmospheric levels. Another use scenario may be for the controller to actuate a solenoid or other valve to vent the vessel.

The controller may alert the user or otherwise cause the vessel to be vented near the time when fermentation may be expected to be completed. In some cases, the controller may cause the venting to occur at some point prior to the expected time when fermentation may be completed.

The venting may cause the pressure in the fermentation vessel to go down, and the fermentation process may then cause the pressure to rise. The rate at which pressure rises or the time taken to reach full pressurization may be used by the controller to determine how close the fermentation process may be to completion. In some scenarios, the venting may be done several times throughout the fermentation cycle to measure the performance of fermentation. In many such scenarios, the controller may update an estimated time to completion with each analysis.

The fermentation system may include a pressure vessel along with a removable cover for the vessel. In some scenarios, the removable lid may include a pressure sensor, a relief valve, a regulator, and other components, such as a temperature sensor, a controller, power supply for the controller, and other components. Such a design may consolidate the fermentation components into a single, removable device.

When fermentation may be complete, the user may transfer the fermented material into another vessel for storage or dispensing. Other designs may replace the removable lid with fermentation-specific sensors and controller with a removable lid with connections for a dispensing device or a removable lid for storage.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory. When the subject matter is embodied in “non-transitory” media, the media may be any storage media that expressly does not include live signals.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

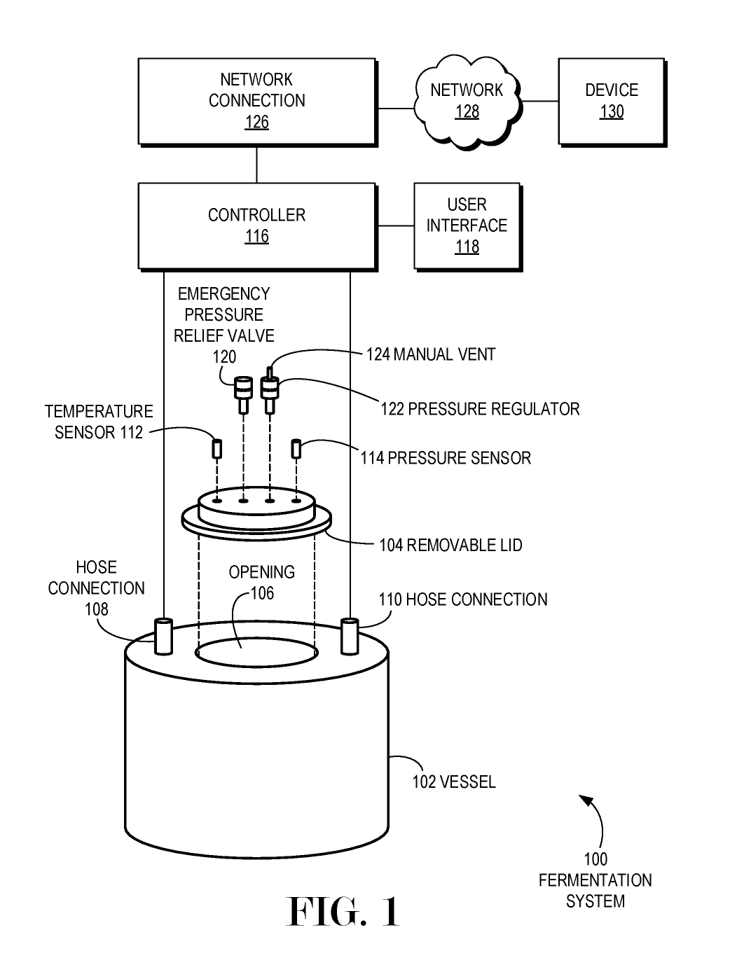

FIG. 1 is a diagram illustration of an embodiment 100 showing various components that may make up a fermentation system. Embodiment 100 may be one example of a fermentation system that may be used to ferment beer, for example, or other foodstuffs.

A vessel 102 may have a removable lid 104. The removable lid 104 may be a lid designed for fermentation, and the vessel 102 may have other uses, such as for brewing, carbonating, or dispensing. Some such embodiments may change out the removable lids for brewing, carbonating, dispensing, or other uses.

The vessel 102 may have an opening 106 through which the removable lid 104 may be inserted and attached. An attachment mechanism for securing the removable list 104 into the vessel 102 is not shown in this illustration. The vessel 102 may have hose connections 108 and 110, which may be used for filling and emptying the vessel 102, and may not be used for the actual fermentation process.

The vessel 102 may be capable of holding some amount of pressure. For beermaking, the vessel 102 may be capable of 10 to 50 psig pressure, although some vessels may be capable of more or less pressure.

The removable lid 104 may be outfitted with a temperature sensor 112 and pressure sensor 114, which may be connected to a controller 116. The sensors and other components being fitted in the removable lid 104 may allow for a generic vessel 102 to be converted to a fermentation vessel merely by installing and connecting the removable lid 104.

The controller 116 may receive input from the temperature sensor 112 and pressure sensor 114, and may monitor a fermentation cycle, as well as determine when a fermentation cycle has completed.

The controller 116 may have a user interface 118 whereby a user may communicate with the controller 116. Some embodiments may have a network connection 126, where the controller may be connect to a network 128 and a remote device 130. The remote device 130 may provide input or receive alerts, or may provide recipe information, or perform some other function.

The removable lid 104 may have an emergency pressure relief valve 120. In many cases, the emergency pressure relief valve 120 may be a failsafe device that may vent the vessel 102 when the internal pressure reaches a maximum limit. In general, the emergency pressure relief valve 120 may only be tripped to prevent a dangerous situation from occurring, and in normal operation, the pressure inside the vessel 102 may not approach the maximum pressure. For many vessels used in beermaking an emergency pressure relief valve 120 may be set to vent pressures over 10 psig.

A pressure regulator 122 may be a pressure relief valve that may be calibrated for a specific pressure. In many cases, an emergency pressure relief valve may not be very accurate, as the main purpose may be to vent high pressures and prevent dangerous explosions. In contrast, a pressure regulator 122 may be more accurate and repeatable. In many cases, the pressure regulator 122 may be adjustable, while in other cases, the pressure regulator 122 may have a fixed setting.

The pressure regulator 122 is illustrated has having a manual vent 124. The manual vent 124 may be a button or other mechanical mechanism whereby a user may relieve the pressure inside the vessel 102 and thereby vent the pressure to atmosphere. Typically, a user may vent the pressure to remove the lid, for example.

As will be described below, the controller 116 may alert the user to manually vent to the pressure during fermentation, then monitor the pressure recovery to determine if fermentation has completed or to assess how much more time may be expected before fermentation completes.

The controller 116 may be mounted on the removable lid 104 in some cases. In other cases, a device may be mounted on the removable lid 104, and such a device may communicate pressure and temperature readings to a controller 116 which may be mounted remotely.

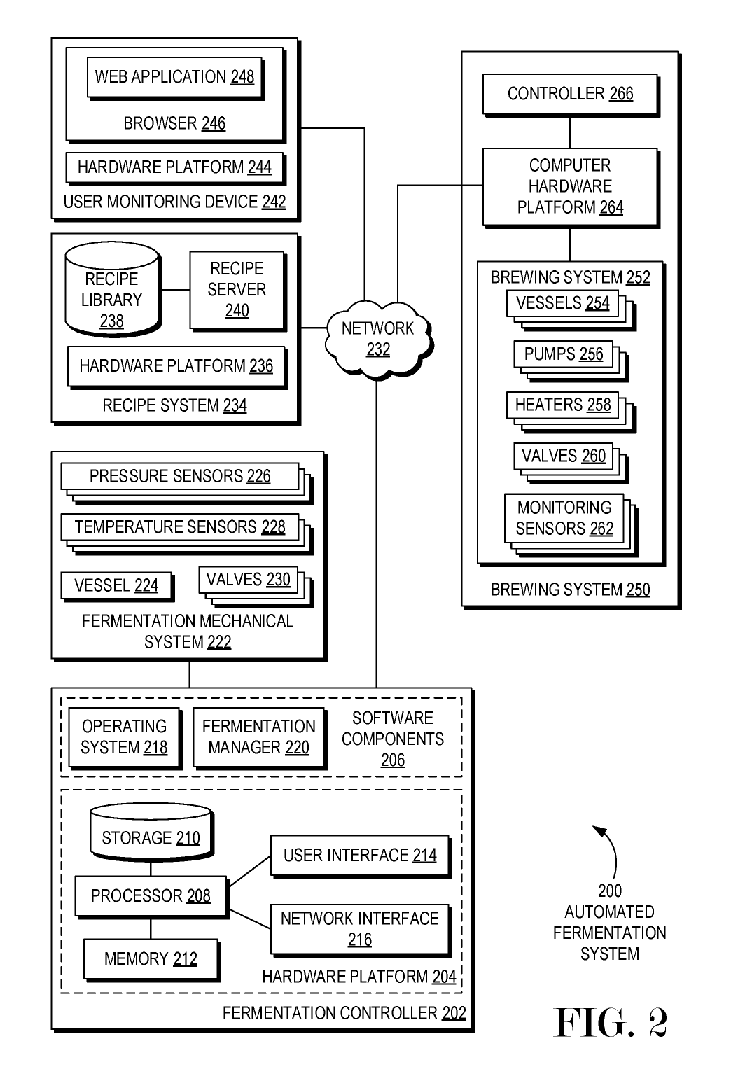

FIG. 2 is a diagram of an embodiment 200 showing schematic of a fermentation system that may be operated as part of a beer making system. The various components may be connected by network 232.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a fermentation controller 202 that may have a hardware platform 204 and various software components. The fermentation controller 202 as illustrated represents a conventional computing device, although other embodiments may have different configurations, architectures, or components.

In many embodiments, the fermentation controller 202 may be a server computer. In some embodiments, the fermentation controller 202 may still also be a desktop computer, laptop computer, netbook computer, tablet or slate computer, wireless handset, cellular telephone, game console or any other type of computing device. In some embodiments, the fermentation controller 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A fermentation manager 220 may be a component that may monitor and control the fermentation process. The fermentation manager 220 may collect information and data about the fermentation process, and may determine when the fermentation process may be completed.

The fermentation controller 202 may operate in conjunction with a fermentation mechanical system 222. The fermentation mechanical system 222 may have one or more vessels 224, as well as pressure sensors 226, temperature sensors 228, and, in some cases, valves 230 which may be controllable by the fermentation controller 202.

The fermentation mechanical system 222 may be fully automated in some cases. A fully automated system may have valves, plumbing, and other mechanisms by which fermenting liquid may be transferred into and out of the vessel, as well as sensors that may monitor the status of the fermentation. Some automated systems may monitor multiple vessels, each of which may be undergoing fermentation at different stages, and in some cases, using different recipes and fermenting different foodstuffs.

The fermentation mechanical systems may have various pressure sensors 226. The pressure sensors 226 may monitor the pressure inside the vessels. In many cases, a fermentation manager may monitor the pressure inside a fermentation vessel, and the pressure measurement may be used to determine that fermentation has begun or if fermentation has not started as expected. The pressure measurement may also be used to determine if fermentation has ended or is nearing completion.

The temperature sensors 228 may be used to measure ambient temperature, vessel temperature, liquid temperature, or other temperature relating to the fermentation process. In general, a more accurate temperature for fermentation monitoring may be liquid temperature inside the vessel, but some designs may use ambient temperature or vessel temperature as a proxy or substitute for internal liquid temperature.

The valves 230 may be two types of valves: valves that may be used to configure plumbing for moving liquid into and out of vessels, as well as valves that may be used to automatically vent pressure inside a vessel. In automated industrial systems, pumps, valves, and other plumbing may be used to move material into and out of vessels. Some such systems may include automated cleaning systems.

The fermentation controller 202 may be connected to the fermentation mechanical system 222 in several different ways. Some systems may have the fermentation controller 202 mechanically attached to the mechanical system. One such example may be a small controller that may be mounted onto a removable lid of a fermentation system.

Other systems may have the fermentation controller 202 that may be located remotely, such as a version where the fermentation controller 202 may be a process that may operate in the cloud. Such a remote controller may have a device that may capture temperature and pressure measurements and may pass the measurements to the controller. The controller may process the measurements and may pass information to a user through various user interfaces.

A network 232 may be any type of communications network that may pass communications from one device to another. One example of such a network may be the internet.

A recipe system 234 may provide information about a recipe. Such information may be used to estimate a fermentation cycle. For example, a beer recipe may be used to determine the expected amount of sugars to be fermented, as well as a specific strain of yeast or bacteria to be inoculated. From these data, an estimated length of time for a fermentation cycle may be calculated.

A recipe system 234 may have a hardware platform 236 on which a recipe library 238 and a recipe server 240 may operate. In a typical use cases, a query may be made to the recipe server 240, and information about a recipe may be returned. In some cases, a recipe server 240 may calculate a fermentation performance curve or other representation of a fermentation process. In other cases, raw recipe information, such as an ingredient list, may be passed to a fermentation controller 202, and the fermentation controller 202 may determine various representations about an expected fermentation cycle.

A user monitoring device 242 may be a device through which a user may remotely interact with the fermentation monitor 202. The user monitoring device may be a hardware platform 244 with a browser 246 which may execute a web application 248. The web application may send data to and receive data from the fermentation controller 202. In a typical use case, a user may configure the fermentation controller 202 for a fermentation cycle, then may receive data, alerts, and other information from the fermentation controller 202. For example, the user monitoring device 242 may be a cellular telephone that may be used to configure a fermentation process, as well as to receive alerts about potential problems with the fermentation, status of the process, when to interact with the fermentation vessel, and when the fermentation may be complete.

A brewing system 250 may be a beer brewing system that may operate in conjunction with a fermentation system. In some cases, operations of the fermentation controller 202 may be incorporated in to a brewing system.

The brewing system 250 may include a hardware system 252 that may have various vessels 254, pumps 256, heaters 258, valves 260, monitoring sensors 262, and other apparatus.

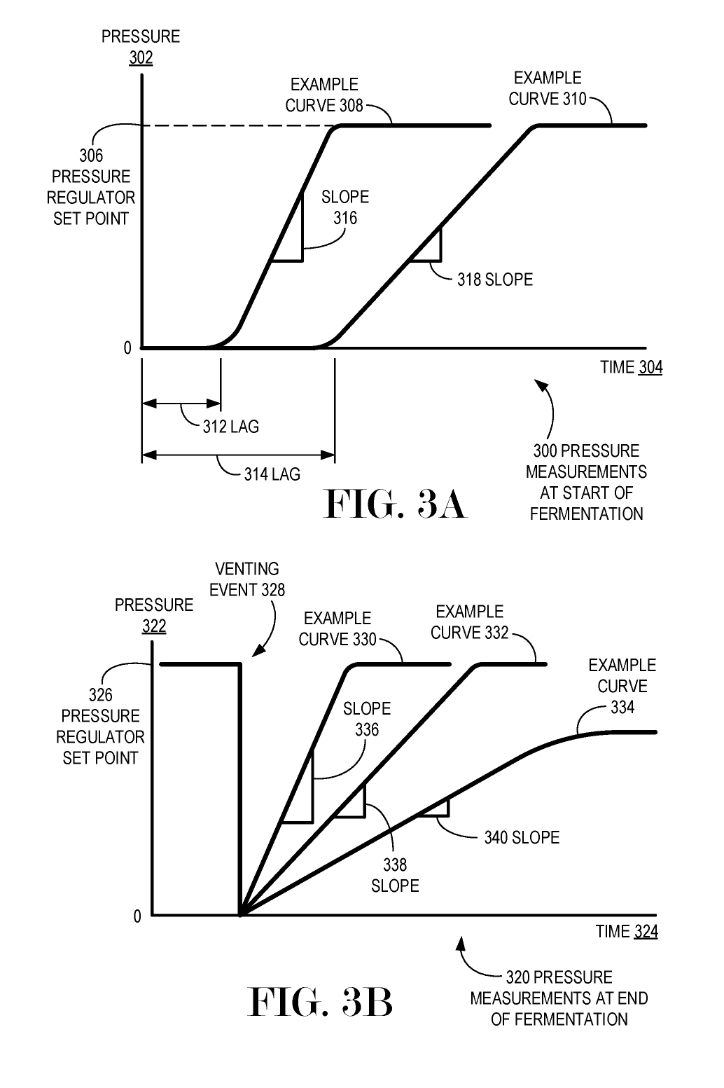

FIG. 3A is a diagram illustration of an embodiment 300 showing pressure measurements at the start of a fermentation cycle. The illustration is not to scale. Embodiment 300 shows two curves for pressure 302 verses time 304.

Curves 308 and 310 illustrate two different fermentation cycles. Curve 308 may show a fermentation cycle that may start earlier and more aggressively than curve 310, which may start later and progress slower. Each of the curves begin at atmospheric pressure, then may progress to a pressure regulator set point 306. At the pressure regulator set point 306, any excess pressure may be vented, so a fermentation manager may not be able to detect the amount or rate of increase of pressure.

At the beginning of each fermentation cycle, typically yeast, bacteria, or other organism may be introduced into the wort or other raw material. The organisms may take a period of time to begin reproducing, and their effects may take some time to begin to be measured. The lag times 312 and 314 represent two different cycles where it took longer for the cycle of curve 310 to begin to produce measurable results.

Many fermentation monitors may predict the beginning of a fermentation cycle by determining a maximum lag time for a fermentation cycle to begin. If the fermentation cycle does not begin prior to the maximum lag time, a fermentation manager may alert the user to attend to the vessel.

A troubleshooting sequence may begin when the lag time exceeds a maximum lag time. The troubleshooting sequence may have the user check that any removable lids or other accessories are properly seated and installed. The sequence may instruct the user to open the vessel and see if there is foam in the vessel, which may indicate that fermentation has begun. If foam is present, the user may be instructed to seal the vessel and continue monitoring. Provided that fermentation has begun, the pressure in the vessel should rise once it is properly sealed and is pressure-tight.

If foam is not present, the user may be instructed to add another charge of yeast or bacteria and the fermentation cycle may be restarted. In such a case, any lag time measurement may be restarted and the diagnostic troubleshooting sequence may be executed again if pressure rise is not measured by the end of maximum lag time.

In the example of embodiment 300, if both fermentation curves were for the same recipes and yeast, the curve 308 may represent a fermentation cycle that may have operated under higher temperatures than curve 310. The slopes 316 and 318 may represent the rate of reproduction of the yeasts or bacteria in the fermentation cycle. The rate of fermentation may be directly related to the temperature of the liquid, and the rate may be used to forecast or estimate the completion time of the fermentation cycle.

Some fermentation monitoring systems may have an expected rate of fermentation based on the recipe and temperature. For cycles that progress much faster than an expected rate, a fermentation monitoring system may flag the cycle as excessively high. Sometimes, such a situation may be caused by having additional and unwanted bacteria or other organisms in the fermentation. Such unwanted organisms may overtake the intended yeast or bacteria, and may cause a bad batch. In some cases, the user may have prepared the yeast by starting it in a small batch of high sugar liquid to start the fermentation process. In such cases, fermentation may progress much faster than expected if no such starter were used.

FIG. 3B is a diagram illustration of an embodiment 320 showing pressure measurements at the end of a fermentation cycle. The illustration is not to scale. Embodiment 320 shows three curves for pressure 322 verses time 324.

Curves 330, 332, and 334 illustrate three different fermentation curves. Each of the curves may begin with pressure at a pressure regulator set point 326. Nearing the end of the fermentation cycle, a venting event 328 may occur, where the pressure may be reduced back to atmospheric pressure. The venting event 328 may be automated with an automated valve, or by alerting a user to manually vent the fermentation vessel.

The performance of the fermentation cycle may be determined by the response of pressure measurements after venting. Curve 330 may illustrate a fermentation cycle that may have longer to go, as the pressure regains quickly. Curve 332 may be an example of a fermentation cycle that may be nearing completion, as the curve takes longer to reach the pressure regulator set point. Such a situation may occur when the amount of available sugars may have been consumed. Curve 334 may represent an example of a fermentation cycle that may have reached completion, as the yeast may not regenerate enough to reach the pressure regulator set point.

A fermentation manager may analyze the slopes 336, 338, and 340 to estimate how much longer the fermentation cycle may have before completion. When the fermentation cycle has completed or is sufficiently near completion, the user may be alerted to proceed to another stage of manufacturing. In the case of beer, the next stage may be carbonation and serving, for example.

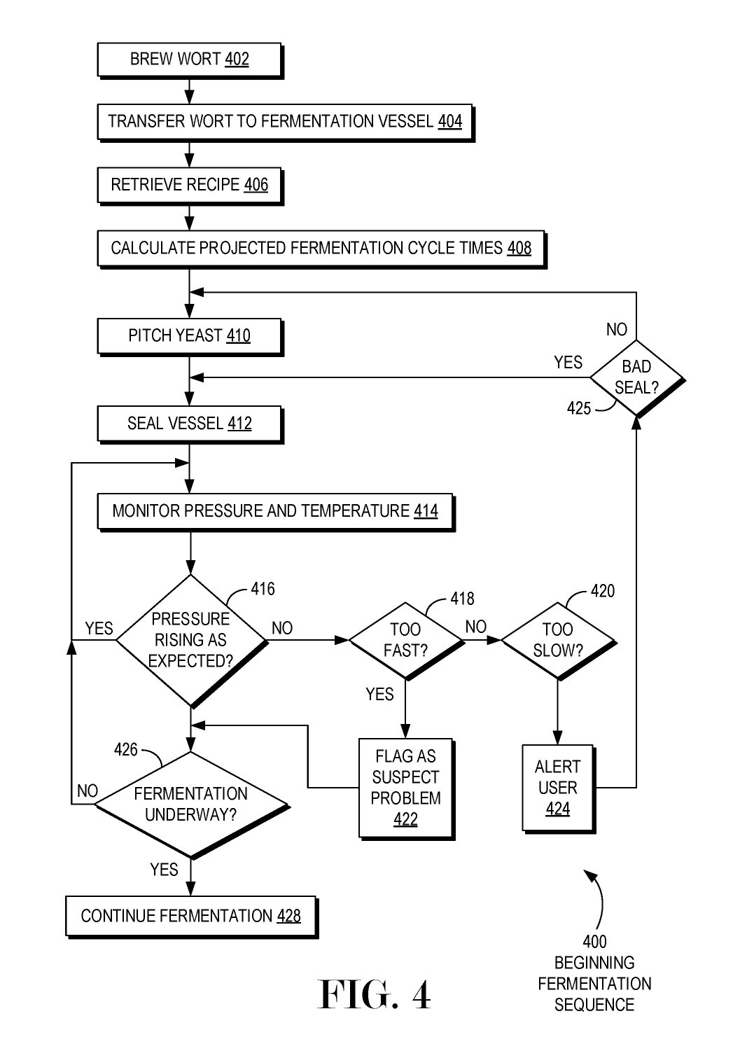

FIG. 4 is a flowchart illustration of an embodiment 400 showing steps a fermentation manager may perform to manage the beginning portion of a fermentation cycle.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 402, wort may be brewed. The wort may be transferred to a fermentation vessel in block 404. Wort may contain various sugars that may be consumed by yeast during fermentation.

A recipe may be retrieved in block 406, and from the recipe, a projected fermentation cycle may be calculated in block 408. In general, a fermentation cycle may be calculated by determining the amount of sugars available for consumption by a yeast, and by knowing the rate at which the yeast consumes the sugars, an estimated fermentation cycle may be calculated. The projected or estimated fermentation cycle may be used as a basis to determine how much the actual fermentation cycle deviates from the norm, and whether alerts or other action may be taken.

Yeast may be pitched into the wort in block 410. The vessel may be sealed in block 412, and the pressure and temperature may be monitored in block 414.

If the pressure does not begin rising as expected in block 416, some actions may be taken. If the pressure is rising faster than expected in block 418, the fermentation cycle may be flagged as a suspect problem in block 422 and the cycle may continue.

If the pressure is rising slower than expected in block 420, the user may be alerted in block 424. The user may be alerted to check the vessel for any pressure leaks, such as if a removable lid was not fully seated or some other possible leaks. The user may also be instructed to look inside the vessel for any traces of foam, which may indicate that fermentation has begun. If foam is present, the diagnosis may be a bad seal in block 425, and the process may return to block 412 to seal the vessel. If foam is not present, the diagnosis may be that the yeast is not performing, and the process may return to block 410.

If the fermentation process is not underway in block 426, the process may return to block 414. If the process is underway in block 426, fermentation may continue in block 428.

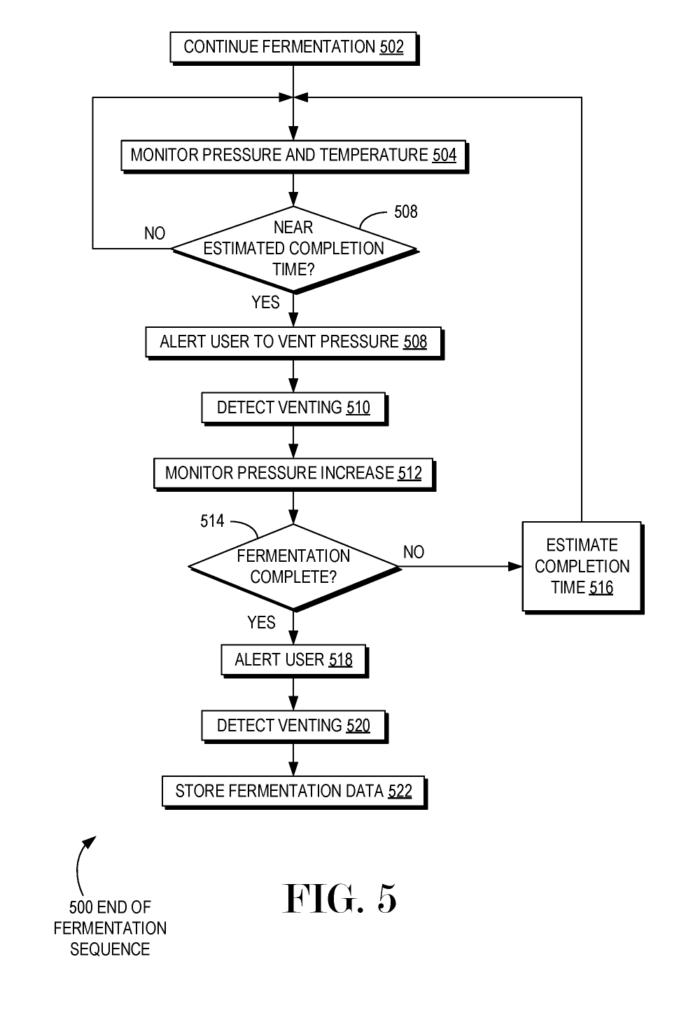

FIG. 5 is a flowchart illustration of an embodiment 500 showing steps a fermentation manager may perform to manage the ending portion of a fermentation cycle.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Fermentation may continue in block 502 from embodiment 400.

Pressure and temperature may be monitored in block 504. The process may cycle in block 506 until the cycle nears an estimated completion time.

When the estimated completion time is reached in block 506, an alert may be sent to a user in block 508 to vent the pressure in the vessel. The venting may be detected in block 510 when the pressure drops to atmospheric or near-atmospheric.

The system may monitor the pressure increase in block 512 after venting, and a determination may be made in block 514 if fermentation may be complete. If fermentation is not complete in block 514, an updated fermentation time may be calculated in block 516 and the process may return to block 504.

If fermentation may be completed in block 514, the user may be alerted in block 518 to proceed with another step in manufacturing. The venting may be detected in block 520 and the fermentation data may be stored in block 522 for later review.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A device comprising:
a vessel;
a pressure sensor connected to a controller and positioned to measure pressure inside said vessel;
a pressure relief valve;
a pressure regulator having a first set point;
a controller configured to:
determine that a fermentation cycle is expected to be completed inside said vessel;
cause said pressure to be relieved inside said vessel;
detect that pressure has been relieved inside said vessel from said pressure sensor;
measure a pressure increase inside said vessel after said pressure has been relieved from said vessel; and
determine that said fermentation cycle has ended based at least in part on said pressure increase.

2. The device of claim 1, said controller further configured to:
determine that said fermentation cycle has begun;
measure an initial pressure increase inside said vessel during said fermentation cycle; and
determine an estimated future time when said fermentation cycle is to be completed.

3. The device of claim 1 further comprising:
a temperature sensor;
said controller further configured to:
receive a temperature reading from said temperature sensor; and
determine that said fermentation cycle has ended based at least in part on said temperature reading.

4. The device of claim 3, said temperature sensor being configured to measure ambient temperature.

5. The device of claim 3, said temperature sensor being configured to measure temperature inside said vessel.

6. The device of claim 5, said temperature sensor being configured to measure liquid temperature of said fermentation cycle.

7. The device of claim 1, said pressure relief valve being a manual valve.

8. The device of claim 7, said controller further configured to:
alert a user to relieve pressure using said pressure relief valve.

9. The device of claim 1, said pressure relief valve being a valve controllable by said controller.

10. The device of claim 1, said vessel being a pressure vessel capable of at least 10 psig.

11. The device of claim 10, said first set point being at least 5 psig.

12. A controller for a fermentation system, said fermentation system having a pressure sensor generating a pressure signal representing pressure inside a fermentation vessel, said controller adapted to:
determine that a fermentation cycle is expected to be completed inside said vessel;
cause said pressure to be relieved inside said vessel;
detect that pressure has been relieved inside said vessel from said pressure sensor;
measure a pressure increase inside said vessel after said pressure has been relieved from said vessel; and
determine that said fermentation cycle has ended based at least in part on said pressure increase.

13. The controller of claim 12 further configured to:
determine that said fermentation cycle has begun;
measure an initial pressure increase inside said vessel during said fermentation cycle; and
determine an estimated future time when said fermentation cycle is to be completed.

14. The controller of claim 13 further configured to:
receive a temperature reading from said temperature sensor; and
determine that said fermentation cycle has ended based at least in part on said temperature reading.

15. The controller of claim 12 further configured to:
alert a user to relieve said pressure inside said vessel.

16. The controller of claim 12 further configured to:
alert a user that said fermentation cycle has ended.

17. The controller of claim 12 further configured to:
receive a recipe comprising ingredients; and
estimate a length for said fermentation cycle based at least in part on said ingredients.

18. A removable lid for a pressure vessel, said removable lid comprising:
a pressure sensor connected to a controller and positioned to measure pressure inside said vessel;
a pressure relief valve;
a pressure regulator having a first set point;
a controller configured to:
determine that a fermentation cycle is expected to be completed inside said vessel;
cause said pressure to be relieved inside said vessel;
detect that pressure has been relieved inside said vessel from said pressure sensor;
measure a pressure increase inside said vessel after said pressure has been relieved from said vessel; and
determine that said fermentation cycle has ended based at least in part on said pressure increase.

19. The removable lid of claim 18, said controller further configured to:
determine that said fermentation cycle has begun;
measure an initial pressure increase inside said vessel during said fermentation cycle; and
determine an estimated future time when said fermentation cycle is to be completed.

20. The removable lid of claim 19 further comprising:
a temperature sensor;
said controller further configured to:
receive a temperature reading from said temperature sensor; and
determine that said fermentation cycle has ended based at least in part on said temperature reading.
